(19) United States
(12) Patent Application Publication
(10) Pub. No.: US 2026/0340618 A1
(43) Pub. Date: Oct. 29, 2026

(54) USER INITIATED OFFLINE TRANSACTIONS VIA TEXT MESSAGING

(71) Applicant: Truist Bank, Charlotte, NC (US)

(72) Inventor: Prasad P. Jahagirdar, Charlotte, NC (US)

(73) Assignee: Truist Bank, Charlotte, NC (US)

(21) Appl. No.: 19/188,907

(22) Filed: Apr. 24, 2025

(51) Int. Cl. G06Q 20/32; G06Q 20/40

(52) U.S. Cl. CPC G06Q 20/3255; G06Q 20/409

(57) ABSTRACT

A computer-implemented method is presented in accordance with an embodiment for conducting external transactions and/or internal transactions via text messaging. The computer-implemented method includes receiving a text message relating to an external transaction and/or internal transaction, with the text message being sent by a requesting device. The computer-implemented method also includes determining an identity of the requesting device, and verifying that the requesting device is registered for conducting external transactions and/or internal transactions for at least one account. The computer-implemented method further includes determining whether the text message comprises a request string that is recognizable in response to verifying that the requesting device is registered. Moreover, the computer-implemented method includes performing the external transaction and/or internal transaction in association with the at least one account in response to determining that the request string is recognizable.

### TECHNICAL FIELD

The present invention relates to transactions, and more specifically, the present invention relates to facilitating user initiated offline transactions via text messaging.

### BACKGROUND

The current landscape of payments and money transfers predominantly relies on web-based interfaces, which cater to users who have consistent access to the internet and are comfortable with web-based transactions. This approach, however, is limited for users who prefer or require non-web-based methods, such as those in areas with limited internet connectivity or those who prioritize security and privacy. Moreover, existing solutions often fail to provide a comprehensive offline mechanism (e.g., without access to the Internet) for managing and canceling future external transactions and/or internal transactions (e.g., purchase transactions payments, deposits, transfers, etc.), particularly through non-web-based methods such as short message service (SMS) and/or multimedia messaging service (MMS). This limitation is particularly pronounced in scenarios where users need to manage certain external transactions and/or internal transactions (e.g., purchase transactions) without immediate access to the internet, such as during travel or in remote locations.

Current systems for facilitating offline transactions typically involve receiving payment requests from merchant devices and providing payment approval messages, which are later transferred to a payment server once network connectivity is restored. These systems ensure that only one user device is enabled for offline payments at a time to prevent overdrawing of accounts. They do not offer offline capabilities for managing and canceling future payments or transfers. The existing solutions do not allow users to have control over their external transactions and/or internal transactions through offline means.

Moreover, existing cloud-based systems that act as intermediaries between mobile devices and enterprise computer systems for processing external transactions and/or internal transactions often handle different communication protocols and/or security protocols, but do not allow for offline management of future payments or transfers. These systems are designed to facilitate real-time transactions and do not provide the necessary offline capabilities to allow users to manage their external transactions and/or internal transactions securely and efficiently.

The lack of an integrated offline management system leaves a significant gap in the current technological landscape, particularly for users who require a more flexible and secure method for managing their external transactions and/or internal transactions.

### SUMMARY

In one embodiment, a computer-implemented method is presented for conducting external transactions and/or internal transactions via text messaging. The computer-implemented method includes receiving, at an enterprise server, a text message relating to an external transaction and/or internal transaction, with the text message being sent by a requesting device. The computer-implemented method also includes determining, by the enterprise server, an identity of the requesting device, and verifying, by the enterprise server, that the requesting device is registered for conducting external transactions and/or internal transactions for at least one account. The computer-implemented method further includes determining, by the enterprise server, whether the text message comprises a request string that is recognizable by the enterprise server in response to verifying that the requesting device is registered. Moreover, the computer-implemented method includes performing, by the enterprise server, the external transaction and/or internal transaction in association with the at least one account in response to determining that the request string is recognizable.

In an embodiment, a system is presented for conducting external transactions and/or internal transactions via text messaging. The system includes at least one processor and a non-transitory computer-readable medium having instructions embodied therewith that, when executed by the at least one processor, cause the at least one processor to perform operations. The operations include receiving, at an enterprise server, a text message relating to an external transaction and/or internal transaction, with the text message being sent by a requesting device. The operations also include determining, by the enterprise server, an identity of the requesting device, and verifying, by the enterprise server, that the requesting device is registered for conducting external transactions and/or internal transactions for at least one account. The operations further include determining, by the enterprise server, whether the text message comprises a request string that is recognizable by the enterprise server in response to verifying that the requesting device is registered. Moreover, the operations include performing, by the enterprise server, the external transaction and/or internal transaction in association with the at least one account in response to determining that the request string is recognizable.

In an embodiment, a computer program product is presented for conducting external transactions and/or internal transactions via text messaging. The computer program product includes a non-transitory computer-readable medium having instructions embodied therewith that, when executed by at least one processor, cause the at least one processor to perform operations. The operations include receiving, at an enterprise server, a text message relating to an external transaction and/or internal transaction, with the text message being sent by a requesting device. The operations also include determining, by the enterprise server, an identity of the requesting device, and verifying, by the enterprise server, that the requesting device is registered for conducting external transactions and/or internal transactions for at least one account. The operations further include determining, by the enterprise server, whether the text message comprises a request string that is recognizable by the enterprise server in response to verifying that the requesting device is registered. Moreover, the operations include performing, by the enterprise server, the external transaction and/or internal transaction in association with the at least one account in response to determining that the request string is recognizable.

### DRAWINGS

The various advantages of the exemplary embodiments will become apparent to one skilled in the art by reading the following specification and appended claims, and by referencing the following drawings.

FIG. 1 is a flow chart of a computer-implemented method for performing text message banking, according to one embodiment.

FIG. 2 is a flow chart of a computer-implemented method for performing text message banking, according to one embodiment.

FIG. 3 is a flow chart of a computer-implemented method for analyzing a text message for performing text message banking, according to one embodiment.

FIG. 4 illustrates an example of a text message conversation for performing text message banking.

FIG. 5 illustrates an example of a text message conversation for performing text message banking.

FIG. 6 illustrates an example of a text message conversation for performing text message banking.

FIG. 7 shows a block diagram of an example computing system that may implement the features and processes of any of FIGS. 1-6.

FIG. 8 illustrates an example network architecture that may implement the features and processes of any of FIGS. 1-6.

### DESCRIPTION

In the following descriptions, for the purposes of explanation, numerous specific details are set forth to provide a thorough understanding to the reader but are not meant to limit the claimed invention in any way. One or more embodiments may be practiced without these specific details. Features described in one embodiment may be used in combination with features described in a different embodiment in various possible combinations and permutations. In some examples, well-known structures and devices are described with reference to block diagrams to avoid unnecessarily obscuring the claimed invention.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

### Definitions

Several non-limiting example definitions are provided below for clarity and illustrative purposes in reading these descriptions and should not be construed to limit the scope of the one or more embodiments disclosed herein in any manner. It is also contemplated that these and other terms may also be defined by their common uses in the context of these descriptions.

The term “about” as used herein indicates the value preceded by the term “about,” along with any values reasonably close to the value preceded by the term “about,” as would be understood by one of skill in the art. When not indicated otherwise, the term “about” denotes the value preceded by the term “about” ±10% of the value. For example, “about 10” indicates all values from and including 9.0 to 11.0.

As used herein, “application” may relate to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into individual applications which reside on a client device (e.g., virtual private network (VPN) client, Microsoft® PowerPoint®, Microsoft® Excel®, etc.) and cloud applications which may reside in the cloud (e.g., Google® Gmail®, GitHub®). Cloud applications may correspond to applications on the client device or may be multi-user applications, such as social media applications (e.g., Facebook®, Linkedin®, etc.).

As used herein, “artificial intelligence” or “AI” may relate to one or more computer systems operable to perform one or more tasks that normally require human intelligence and learning capabilities, such as visual perception, speech recognition, decision-making, and translation between languages.

As used herein, “dynamically” may relate to events or actions that can be caused, triggered, or otherwise occur without human intervention.

As used herein, “machine learning” may relate to an application of AI that provides computer systems the ability to automatically learn and improve from data and experience without being explicitly programmed.

As used herein, “computer” may relate to a single computer or to a system of interacting computers. A computer is a combination of a hardware system, a software operating system and perhaps one or more software application programs. Examples of a computer include, without limitation, a personal computer (PC), a desktop computer, a server, a mainframe, an appliance device, a laptop computer, a smartphone, a satellite phone, a tablet computer, etc.

As used herein, “client device” may relate to any system, apparatus, and/or device associated with a user (who may be a client, customer, administrator, or some other person accessing the device), including personal computers, laptops, tablets, and/or mobile smartphones.

As used herein, “modules” may relate to software modules (e.g., code embodied on a machine-readable medium or in a transmission signal), hardware modules, or a combination thereof. Certain embodiments are described herein as including logic or a number of components, modules, or mechanisms.

As used herein, a “software module” (or just “software”) may relate to code embodied on a computer-readable medium or in a transmission signal for performing or causing performance of one or more tasks by one or more processors. Software may relate to a set of instructions and associated documentation that direct one or more processors or a computer what to do or how to perform a task. Software may include any different types of software programs executable on a computer, such as applications and/or the operating system. A software application may be written in substantially any suitable programming language, which would be easily selectable by one of ordinary skill in the art. The programming language chosen should be compatible with the computer by which the software application is to be executed and, in particular, with the operating system of that computer. Examples of suitable programming languages include, without limitation, Object Pascal, C, C++, Common Gateway Interface (CGI), Java, Java Scripts, etc. Further, the functions of some embodiments, when described as a series of steps for a computer-implemented method, could be implemented as a series of software instructions for being operated by a processor, such that the embodiments could be implemented as software, hardware, or a combination thereof.

A “hardware module” (or just “hardware”) as used herein may relate to a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field Programmable Gate array (FPGA) or an application specific integrated circuit (ASIC).

A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module.

Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” may relate to any combination of electronic communication networks, including, without limitation, the Internet, a local area network (LAN), a wide area network (WAN), a wireless network, and a cellular network, e.g., General Packet Radio Service (GPRS), Long Term Evolution (LTE), 4G, 5G, etc.

As used herein, “processes” or “methods” are presented in terms of methods or symbolic representations of operations performed on data stored as bits or binary digital signals within a computer-readable memory (e.g., a machine memory). These methods or symbolic representations are examples of techniques used by those of ordinary skill in the art of data processing to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-implemented module” may relate to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” may relate to a server computer or group of computers that acts to provide a service for a certain function or access to a network resource. In various examples, a server may be a physical server, a hosted server in a virtual environment, or software code running on a hardware platform.

As used herein, “service” or “application” may relate to software executable by one or more processors (e.g., an online server or set of servers) to perform one or more tasks and may refer to locally executed software (e.g., operating system, web browser, etc.) or software that is remotely accessible (e.g., a web site, web application, cloud application, etc.).

As used herein, “sensor” may relate to any device, component and/or system that is configured to perform one or more of detecting, determining, assessing, monitoring, measuring, quantifying, and sensing operations.

As used herein, “real-time” may relate to a level of processing responsiveness that a user, module, or system senses as sufficiently immediate for a particular process or determination to be made, or that enables the processor to keep up with an external process.

As used herein, “user” may relate to a consumer, customer, administrator, operator, machine entity, and/or requesting party, and may be human or machine in various approaches.

### Text Message Banking

Existing solutions for external transactions and/or internal transactions (e.g., payments, deposits, transfers, etc.) via web-based interfaces are inadequate for users who prefer or require non-web-based methods. The need for a solution that allows users to manage and cancel future payments and transfers through offline means, such as SMS or MMS, is evident. This would provide a more accessible and secure alternative for managing external transactions and/or internal transactions, especially in scenarios where internet connectivity is limited or unavailable. The current technological landscape lacks a comprehensive solution that addresses these needs, highlighting the necessity for an improved system that offers robust offline capabilities for managing external transactions and/or internal transactions.

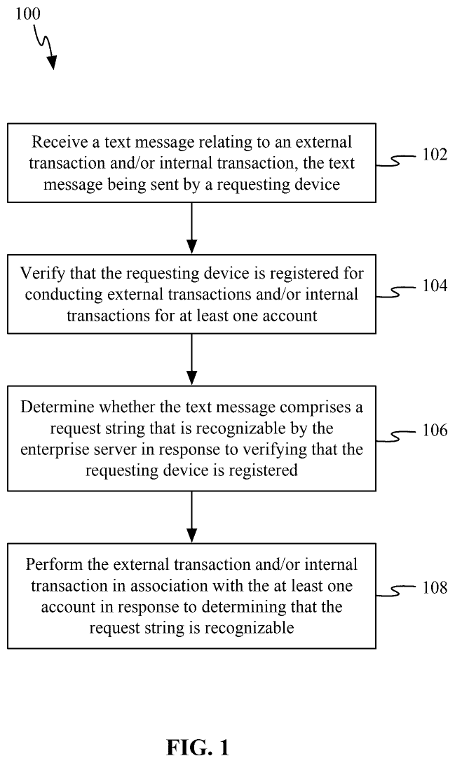

Referring now to FIG. 1, a flow chart of a computer-implemented method 100 for conducting external transactions and/or internal transactions via text messaging (also referred to as performing text message banking) is shown according to one embodiment. Of course, more or less operations than those specifically described in FIG. 1 may be included in computer-implemented method 100, as would be understood by one of skill in the art upon reading the present descriptions.

Each of the operations of computer-implemented method 100 may be performed by any suitable component of the operating environment. For example, in various embodiments, computer-implemented method 100 may be partially or entirely performed by a cloud server, a portable computer, a handheld or wearable computer, a mobile device, one or more hardware processors of a computing device, an application operating on a computing device, a server device, a processing circuit having one or more processors therein, or some other device having one or more processors therein. The processing circuit, e.g., processor(s), chip(s), and/or module(s) implemented in hardware and/or software, and preferably having at least one hardware component, may be utilized in any device to perform one or more operations of computer-implemented method 100. Illustrative processors include, but are not limited to, a CPU, an ASIC, a FPGA, etc., combinations thereof, or any other suitable computing device known in the art.

In one embodiment, computer-implemented method 100 may be performed by an enterprise server that is configured to process electronic external transaction and/or internal transaction requests and manage accounts that are accessible to the electronic banking system. Although computer-implemented method 100 describes the use of text messages for banking, any form of short form or long form message on any platform may be used for initiating an action related to an external transaction and/or an internal transaction for an account, such as Facebook® Messenger messages, Apple® Facetime® messages, WhatsApp™ messages, etc. Moreover, computer-implemented method 100 is described as being performed by an enterprise server; however, any suitable computing device may be used, alone or in combination with other electronic devices, to perform computer-implemented method 100 in various embodiments.

In operation 102, the enterprise server receives all or a portion of a text message relating to an external transaction and/or internal transaction. The text message is sent by a requesting device to initiate a text message banking session, and may be received by the enterprise server for processing thereof, either directly or via one or more intermediary devices, routers, switches, etc. In some examples, the requesting device may be a mobile device of a user, a smartphone, tablet computer, etc., that is connected to a cellular network or Wi-Fi network capable of originating and carrying a text message from the requesting device to the enterprise server.

In various embodiments, the text message may be formulated to adhere to a preset syntax for processing by the enterprise server. Some non-limiting example syntaxes are described below. However, any suitable and recognizable syntax may be used for describing the requested external transaction and/or internal transaction and desired action to be performed.

In several embodiments, the text message may take the following syntax: “TYPE CODE DATE,” “CODE TYPE DATE,” DATE CODE TYPE,” or some other combination of these three parameters (or additional parameters described below). In these embodiments, “TYPE” describes the type of external transaction and/or internal transaction(s) that will be viewed, modified, initiated, or cancelled; “CODE” describes the action to be performed for the external transaction and/or internal transaction(s); and “DATE” indicates the date or starting date associated with the external transaction and/or internal transaction(s).

For example, the “TYPE” parameter may indicate external transactions and/or internal transactions having any of the following types, or others known in the art: automated clearing house (ACH), wire transfer, Zelle®, real time payment (RTP) , Society for Worldwide Interbank Financial Telecommunication (SWIFT), electronic funds transfer (EFT), etc. Each of these types of external transactions and/or internal transactions may be abbreviated when used as a “TYPE” parameter, e.g., “ACH” and/or “A” for ACH transfers and payments, “WIRE” or “W” for wire transfers and payments, “ZELLE” and/or “Z” for Zelle® transfers and payments, “RTP” and/or “R” for RTP transfers and payments, “SWIFT” or “S” for SWIFT international transfers and payments, and “EFT” or “E” for EFT transfers and payments, etc.

In an example, the “CODE” parameter may indicate one of many different actions that may be performed for the related external transaction and/or internal transaction(s), such as set up a new transfer or payment, cancel an existing transfer or payment, retrieve or view one or more (e.g., 1, 3, 5, 10, etc.) of the next scheduled transfers or payments, change an amount of a scheduled transfer or payment, change a recipient of a scheduled transfer or payment, change a date for performing a scheduled transfer or payment, etc. Each of these actions may be abbreviated with a preset code when used as a “CODE” parameter, e.g., “1” to retrieve or view the next three transactions, “5” to create a new transaction, “9” to cancel a next transaction, etc. Of course, different codes may be used to represent the above-described actions in the syntax in place of or in addition to those described above. Moreover, many different actions not specifically described herein may be performed for the related external transaction and/or internal transaction(s) and may have codes assigned thereto for processing from a request string, as would be apparent to one of skill in the relevant art upon reading the present descriptions.

In one example, the “DATE” parameter may indicate a date associated with performance of one or more external transactions and/or internal transactions, or a starting date to view or retrieve scheduled external transactions and/or internal transactions. The “DATE” parameter may be entered as numerical digits, e.g., “DDMMYYYY,” “MMDDYYYY,” “YYYYMMDD,” “DDMMYY,” or as a combination of digits and alphabetic characters, e.g., “DDMMMYY,” or in accordance with some other date convention that would be known to one of skill in the art. For example, Mar. 25, 2025 may be entered as “25032025,” 03252025,” “20250325,” “250325,” “25MAR25,” etc.

In operation 104, the enterprise server verifies that the requesting device is registered for conducting external transactions and/or internal transactions for at least one account. This determination will dictate whether computer-implemented method 100 should continue, in one approach, as a device that is not registered for conducting external transactions and/or internal transactions via text messaging will not be allowed to proceed with text message banking.

A registration process may be conducted when a user desires to have a device authorized for conducting external transactions and/or internal transactions for at least one account associated with the user. This registration process may proceed as described herein, or take some other form known in the art.

In one embodiment, prior to receiving the text message, the enterprise server may receive an electronic request to register the requesting device for conducting offline external transactions and/or internal transactions for the at least one account. This electronic request may be sent online via a website, through a mobile application installed on the requesting device, via text messaging, or via some other electronic transmission technique. Preferably, the electronic request may be received via a secure electronic channel on which the user has already verified their identity, e.g., via login and password, two-factor authentication, fingerprint, face scan, etc. In response to this electronic request, the enterprise server may determine an identity of the requesting device (using a technique described herein or others known in the art). Once the identity of the requesting device is determined, the enterprise server may determine whether the requesting device is associated with an owner of the at least one account. This determination is based on the identity of the requesting device and the identity of the owner(s) of the accounts. Typically, a mobile device's unique identifier will be associated with a particular user, and when this particular user is an owner of the at least one account managed by the enterprise server, the enterprise server will create a new user profile for this user and requesting device, or may modify an existing user profile associated with the at least one account to indicate registration of the requesting device for conducting offline external transactions and/or internal transactions for the at least one account.

This registration between the requesting device and the at least one account in the user profile may be stored by the enterprise server to be accessed whenever a request is received to perform an action for this user, account(s), or requesting device.

In one embodiment, to verify if the requesting device is registered, the enterprise server may determine an identity of the requesting device. This identification may be used to determine whether the requesting device is registered for conducting external transactions and/or internal transactions for at least one account. Thereafter, the enterprise server will determine, from the text message, a device identifier associated with the requesting device, such as international mobile equipment identity (IMEI), international mobile subscriber identity (IMSI), media access control (MAC) address, etc. The enterprise server may then determine whether the device identifier is associated with a user profile accessible to the enterprise server. This user profile would also be associated with the at least one account.

In a further embodiment, the enterprise server may utilize a third-party service to determine an identity of the requesting device. This third-party service may reveal a unique identifier associated with the requesting device, such as IMEI, IMSI, MAC address, etc. Based on this unique identifier, the enterprise server is configured to determine whether the requesting device is listed as a registered device within a user profile associated with one or more accounts managed by the enterprise server.

In operation 106, the enterprise server determines whether the text message comprises a request string that is recognizable by the enterprise server in response to verifying that the requesting device is registered. The text message may not include a request string at all (in the case of messages mistakenly sent to the enterprise server), but the enterprise server will attempt to identify a request string from the text message by default.

In one embodiment, the enterprise server determines whether the request string is recognizable by parsing the text message to determine individual components of the request string, thereby generating individual portions that the enterprise server can analyze to determine whether those components are recognizable parameters for a request string. The enterprise server then analyzes whether each of the individual components of the request string adhere to a preset syntax, such as those described herein or others known in the art. The enterprise server further determines whether the request string is recognizable based on each of the individual components of the request string adhering to the preset syntax. Responsive to the request string being recognizable, computer-implemented method 100 continues to operation 108. Responsive to the request string not being recognizable, the enterprise server will attempt to help the user enter a recognizable request string, as described below in several embodiments.

In one embodiment, the enterprise server may utilize a machine learning (ML) algorithm and/or artificial intelligence (AI) algorithm to determine whether the text message comprises a request string that is recognizable by the enterprise server. Moreover, this ML and/or AI algorithm may learn, update, and adjust to identify incorrect request strings in the future and make better suggestions on how to properly enter the request string. In a further embodiment, the ML and/or AI algorithm may learn how to identify incorrectly entered request strings and still analyze and process the request string without requiring re-entry by the user.

The ML and/or AI algorithm is trained based on two training data sets, one set having correctly formulated request strings and one set having incorrectly formulated request strings. These incorrectly formulated request strings may be similar to correct request strings, but have one or more defects therein that material affect the ability to process the request. This defect or defects may take any form within the request string, such as a mis-entered or unrecognizable date, incorrect code used for the type or manner of the external transaction and/or internal transaction, incorrect code for the action to be performed, incorrect order for the parameters in the request string, too many or too few parameters in the request string, etc. By training the ML and/or AI algorithm on both recognizable and unrecognizable request strings, the ML and/or AI algorithm will be able to identify those request strings which can be processed (and are entered correctly) and those which need to be re-entered due to a defect in the request string. Further, the ML and/or AI algorithm may be able to suggest or recommend how to adjust the request string to overcome the defect(s) found therein, and may, over time, learn how to overcome defect(s) within a search string without requiring re-entry based on learning from past users' actions regarding request string entry.

In one embodiment, the preset syntax may include: a) a first indication of a manner for conducting the external transaction and/or internal transaction, b) a second indication of an action to process in association with the external transaction and/or internal transaction, and c) an eight-digit date associated with the external transaction and/or internal transaction. These parameters may be required to be received in this exact order, or may be received in any order as long as all required parameters are included in the request string.

More parameters may be included in this preset syntax as being able to be recognized by the enterprise server, but may not be required to be entered. For example, the syntax recognizable from the request string may also include an indication code that specifies a nature of the external transaction and/or internal transaction (e.g., a future payment or transfer, a recurring payment or transfer, a new payment or transfer, etc.), an identifier that specifies a particular account for performance of the external transaction and/or internal transaction (useful when the requesting device or user profile indicates multiple accounts that are available for text banking services to be performed thereon), an amount of money associated with the external transaction and/or internal transaction (useful when setting up new transfers or payments and when modifying an existing payment or transfer), a currency associated with the external transaction and/or internal transaction (useful for foreign transactions), a manner for conducting the external transaction and/or internal transaction (e.g., ACH, wire transfer, Zelle®, RTP, SWIFT, EFT, etc.).

In one embodiment, the action to process in association with the external transaction and/or internal transaction may be one of a set of actions pre-authorized for being conducted via text messaging banking. These actions may be different for different account types (e.g., checking accounts can have debits, savings accounts can have transfers, etc.), and may be processed using different manners for the different accounts. Some example actions include, but are not limited to, cancel payment, cancel transfer, retrieve and/or view one or more next transfers and/or payments (e.g., 1, 3, 5, 10, etc.), skip one or more next payment(s) or charge(s) (e.g., next 1, 2, 3, 5, etc.), initiate new payment, initiate new transfer, etc.

In one embodiment, the action may be one of: cancel payment or transfer, retrieve and/or view one or more next transfers and/or payments, and skip one or more next payment(s) or charge(s). Each of these actions may be denoted by a preset indication code, which when received in the request string, will be understood by the enterprise server as being related to performing the associated action on the at least one account.

In an embodiment, the indication code associated with an action to process in association with the external transaction and/or internal transaction may selected from a group comprising: a code to cancel a future transaction, a code to skip a next payment or charge, a code to initiate a new payment, and a code to initiate a new transfer.

According to one embodiment, the enterprise server may send a response text message to the requesting device in response to determining that the request string is not recognizable. The response text message may include an example syntax to use in entering a request string, along with any other relevant information that would enable the user to enter a recognizable request string in a follow-up text message. Some example information may be indicators for accounts available for performing external transactions and/or internal transactions (based on the user profile), upcoming or scheduled transaction(s), amount of money available in one or more accounts, etc.

Prior to performing the external transaction and/or internal transaction, the enterprise server may receive a second text message from the requesting device in response to sending out the response text message. Further, the enterprise server may determine that the second text message includes a second request string that is recognizable by the enterprise server. In this case, the external transaction and/or internal transaction will be performed based on the second request string instead of the original request string received in the original text message.

In operation 108, the enterprise server performs the external transaction and/or internal transaction in association with the at least one account in response to determining that the request string is recognizable. Performance may include setting up a future payment or transfer, canceling an existing payment or transfer, viewing scheduled payments or transfers, etc.

In an embodiment, the enterprise server may send a response text message to the requesting device in response to determining that the request string is not recognizable. The response text message may take any form, but should include information relevant to aiding the user in entering a recognizable request string. For example, the response text message may include an example syntax to use in entering a request string so that the user's requested banking operation may be understood and performed by the enterprise server.

In one embodiment, after processing the request string in association with performing the external transaction and/or internal transaction, the enterprise server may send a confirmation text message to the requesting device. This confirmation text message may include information relevant to informing the user that the requested action has or will be performed. In an approach, the confirmation text message may include a timestamp associated with performance of the external transaction and/or internal transaction in association with the at least one account.

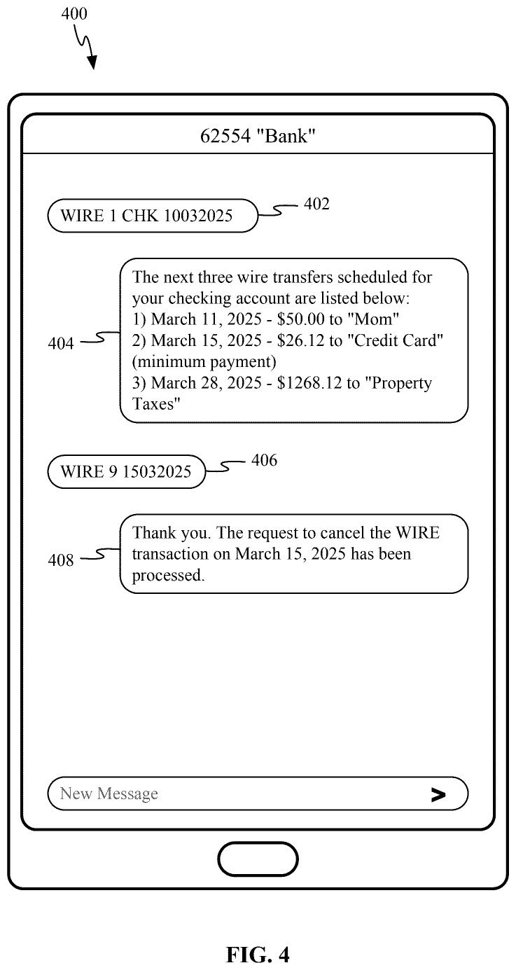

Any of the confirmation text messages presented in FIGS. 4-6 may be used, along with others not specifically described herein. Moreover, information included in the confirmation text message may be selected based on the details of the request string, e.g., the specific details of the request string will affect what script and information are included in the confirmation text message.

Referring again to FIG. 1, computer-implemented method 100 may be implemented in a system and/or a computer program product. For example, a system may include a processing circuit and logic integrated with the processing circuit, executable by the processing circuit, or integrated with and executable by the processing circuit. By integrated with, what is meant is that the processing circuit is a hardware processor that has hardcoded logic included therewith, such as an ASIC, a FPGA, etc. By executable by, what is meant is that the processing circuit is configured to execute software logic to achieve functionality dictated by the software logic. In this example, the logic is configured to cause the processing circuit to perform computer-implemented method 100.

In another example, a computer program product may include a computer-readable storage medium having program instructions embodied therewith. The computer-readable storage medium may be any suitable storage device known in the art that is configured to store and allow processor(s) access to information and data stored therein. In this example, the embodied program instructions are executable by at least one processor to cause the at least one processor to perform computer-implemented method 100.

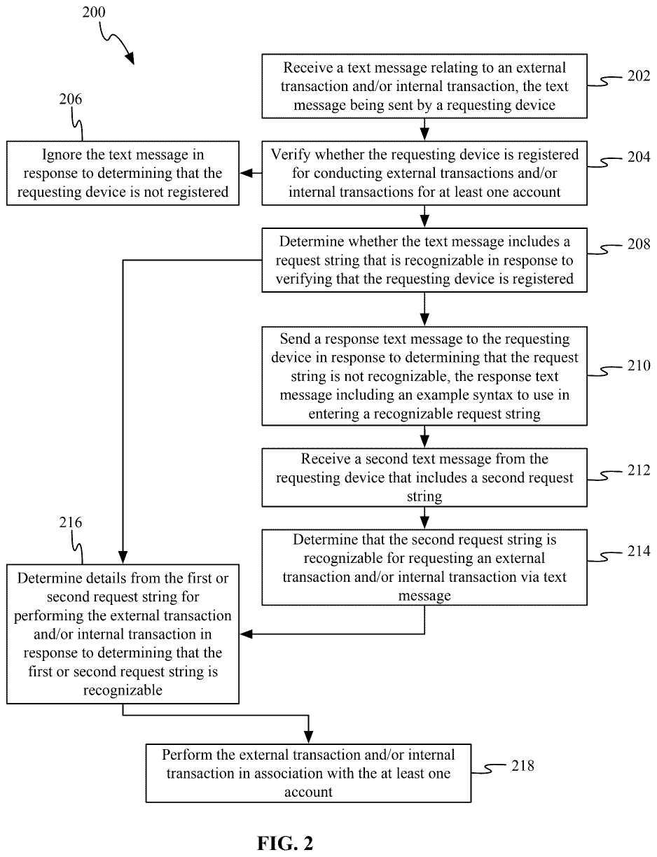

FIG. 2 is a flow chart of a computer-implemented method 200 for performing text message banking, according to one embodiment. Of course, more or less operations than those specifically described in FIG. 2 may be included in computer-implemented method 200, as would be understood by one of skill in the art upon reading the present descriptions.

Each of the operations of computer-implemented method 200 may be performed by any suitable component of the operating environment. For example, in various embodiments, computer-implemented method 200 may be partially or entirely performed by a cloud server, a portable computer, a handheld or wearable computer, a mobile device, one or more hardware processors of a computing device, an application operating on a computing device, a server device, a processing circuit having one or more processors therein, or some other device having one or more processors therein. The processing circuit, e.g., processor(s), chip(s), and/or module(s) implemented in hardware and/or software, and preferably having at least one hardware component, may be utilized in any device to perform one or more operations of computer-implemented method 200. Illustrative processors include, but are not limited to, a CPU, an ASIC, a FPGA, etc., combinations thereof, or any other suitable computing device known in the art.

In one embodiment, computer-implemented method 200 may be performed by an enterprise server that is configured to process electronic external transaction and/or internal transaction requests and manage accounts that are accessible to the electronic banking system. Although computer-implemented method 200 describes the use of text messages for banking, any form of short form or long form message on any platform may be used for initiating an action related to an external transaction and/or internal transaction for a account, such as Facebook® Messenger messages, Apple® Facetime® messages, WhatsApp™ messages, etc. Moreover, computer-implemented method 200 is described as being performed by an enterprise server; however, any suitable computing device may be used, alone or in combination with other electronic devices, to perform computer-implemented method 200 in various embodiments.

In operation 202, the enterprise server receives all or a portion of a text message relating to an external transaction and/or internal transaction. The text message is sent by a requesting device to initiate a text message banking session, and may be received by the enterprise server for processing thereof, either directly or via one or more intermediary devices, routers, switches, etc. In some examples, the requesting device may be a mobile device of a user, a smartphone, tablet computer, etc., that is connected to a cellular network or Wi-Fi network capable of originating and carrying a text message from the requesting device to the enterprise server.

In various embodiments, the text message may be formulated to adhere to a preset syntax for processing by the enterprise server. Some non-limiting example syntaxes are described below. However, any suitable and recognizable syntax may be used for describing the requested external transaction and/or internal transaction and desired action to be performed.

In several embodiments, the text message may take the following syntax: “TYPE CODE DATE,” “CODE TYPE DATE,” DATE CODE TYPE,” or some other combination of these three parameters (or additional parameters described below). In these embodiments, “TYPE” describes the type of external transaction and/or internal transaction(s) that will be viewed, modified, initiated, or cancelled; “CODE” describes the action to be performed for the external transaction and/or internal transaction(s); and “DATE” indicates the date or starting date associated with the external transaction and/or internal transaction(s).

For example, the “TYPE” parameter may indicate external transactions and/or internal transactions having any of the following types, or others known in the art: ACH, wire transfer, Zelle®, RTP, SWIFT, EFT, etc. Each of these types of external transactions and/or internal transactions may be abbreviated when used as a “TYPE” parameter, e.g., “ACH” and/or “A” for ACH transfers and payments, “WIRE” or “W” for wire transfers and payments, “ZELLE” and/or “Z” for Zelle® transfers and payments, “RTP” and/or “R” for RTP transfers and payments, “SWIFT” or “S” for SWIFT international transfers and payments, and “EFT” or “E” for EFT transfers and payments, etc.

In an example, the “CODE” parameter may indicate one of many different actions that may be performed for the related external transaction and/or internal transaction(s), such as set up a new transfer or payment, cancel an existing transfer or payment, retrieve or view one or more of the next scheduled transfers or payments, change an amount of a scheduled transfer or payment, change a recipient of a scheduled transfer or payment, change a date for performing a scheduled transfer or payment, etc. Each of these actions may be abbreviated with a preset code when used as a “CODE” parameter, e.g., “1” to retrieve or view the next three transactions, “5” to create a new transaction, “9” to cancel a next transaction, etc. Of course, different codes may be used to represent the above-described actions in the syntax in place of or in addition to those described above. Moreover, many different actions not specifically described herein may be performed for the related external transaction and/or internal transaction(s) and may have codes assigned thereto for processing from a request string, as would be apparent to one of skill in the relevant art upon reading the present descriptions.

In one example, the “DATE” parameter may indicate a date associated with performance of one or more external transactions and/or internal transactions, or a starting date to view or retrieve scheduled external transactions and/or internal transactions. The “DATE” parameter may be entered as numerical digits, e.g., “DDMMYYYY,” “MMDDYYYY,” “YYYYMMDD,” “DDMMYY,” or as a combination of digits and alphabetic characters, e.g., “DDMMMYY,” or in accordance with some other date convention that would be known to one of skill in the art. For example, Mar. 25, 2025 may be entered as “25032025,” 03252025,” “20250325,” “250325,” “25MAR25,” etc.

In operation 204, the enterprise server verifies that the requesting device is registered for conducting external transactions and/or internal transactions for at least one account. This determination will dictate whether computer-implemented method 200 should continue, in one approach, as a device that is not registered for conducting external transactions and/or internal transactions via text messaging will not be allowed to proceed with text message banking.

In one embodiment, to verify if the requesting device is registered, the enterprise server may determine an identity of the requesting device. This identification may be used to determine whether the requesting device is registered for conducting external transactions and/or internal transactions for at least one account. Thereafter, the enterprise server will determine, from the text message, a device identifier associated with the requesting device, such as IMEI, IMSI, MAC address, etc. The enterprise server may then determine whether the device identifier is associated with a user profile accessible to the enterprise server. This user profile would also be associated with the at least one account.

In a further embodiment, the enterprise server may utilize a third-party service to determine an identity of the requesting device. This third-party service may reveal a unique identifier associated with the requesting device, such as IMEI, IMSI, MAC address, etc. Based on this unique identifier, the enterprise server is configured to determine whether the requesting device is listed as a registered device within a user profile associated with one or more accounts managed by the enterprise server.

In operation 206, the text message is ignored or otherwise disposed of in response to determining that the requesting device is not registered. In another approach, the enterprise server may send a response text message to the requesting device indicating that text message banking is not available for the requesting device. This response text message may further include a link and/or information on how to register the requesting device to conduct text message banking in the future.

A registration process may be conducted when a user desires to have a device authorized for conducting external transactions and/or internal transactions for at least one account associated with the user. This registration process may proceed as described herein, or take some other form known in the art.

In operation 208, the enterprise server determines whether the text message includes a request string that is recognizable by the enterprise server in response to verifying that the requesting device is registered. The text message may not include a request string at all (in the case of messages mistakenly sent to the enterprise server), but the enterprise server will attempt to identify a request string from the text message by default.

In one embodiment, the enterprise server may utilize a ML algorithm and/or AI to determine whether the text message comprises a request string that is recognizable by the enterprise server. Moreover, this ML and/or AI algorithm may learn, update, and adjust to identify incorrect request strings in the future and make better suggestions on how to properly enter the request string, as described herein in various embodiments. In a further embodiment, the ML and/or AI algorithm may learn how to identify incorrectly entered request strings and still analyze and process the request string without requiring re-entry by the user.

Responsive to determining that the request string does not include a request string that is recognizable by the enterprise server, computer-implemented method 200 continues to operation 210. In response to determining that the request string includes a request string that is recognizable by the enterprise server, computer-implemented method 200 continues to operation 216.

In operation 210, the enterprise server sends a response text message to the requesting device in response to determining that the request string is not recognizable in operation 208. The response text message may include an example syntax to use in entering a request string, along with any other relevant information that would enable the user to enter a recognizable request string in a follow-up text message. Some example information may be indicators for accounts available for conducting external transactions and/or internal transactions (based on the user profile), upcoming or scheduled transaction(s), amount of money available in one or more accounts, etc.

In operation 212, the enterprise server receives a second text message from the requesting device in response to sending out the response text message in operation 210.

In operation 214, the enterprise server determines that the second text message includes a second request string that is recognizable by the enterprise server. If the second text message also does not include a recognizable request string, computer-implemented method 200 returns to operation 210.

In operation 216, the enterprise server determines details from the first request string for performing the external transaction and/or internal transaction in response to determining that the first request string is recognizable. Alternatively, the enterprise server determines details from the second request string for performing the external transaction and/or internal transaction in response to determining that the second request string is recognizable (and the first request string is not recognizable).

In operation 218, the enterprise server performs the external transaction and/or internal transaction in association with the at least one account in response to determining that the request string or second request string is recognizable. Performance may include setting up a future payment or transfer, canceling an existing payment or transfer, viewing scheduled payments or transfers, etc.

The external transaction and/or internal transaction will be performed based on the second request string instead of the original request string received in the original text message when operation 208 reveals that the original request string is not recognizable.

In one embodiment, after processing the request string or second request string in association with performing the external transaction and/or internal transaction, the enterprise server may send a confirmation text message to the requesting device. This confirmation text message may include information relevant to informing the user that the requested action has or will be performed. In an approach, the confirmation text message may include a timestamp associated with performance of the external transaction and/or internal transaction in association with the at least one account.

Computer-implemented method 200 may be implemented in a system and/or a computer program product. For example, a system may include a processing circuit and logic integrated with the processing circuit, executable by the processing circuit, or integrated with and executable by the processing circuit. By integrated with, what is meant is that the processing circuit is a hardware processor that has hardcoded logic included therewith, such as an ASIC, a FPGA, etc. By executable by, what is meant is that the processing circuit is configured to execute software logic to achieve functionality dictated by the software logic. In this example, the logic is configured to cause the processing circuit to perform computer-implemented method 200.

In another example, a computer program product may include a computer-readable storage medium having program instructions embodied therewith. The computer-readable storage medium may be any suitable storage device known in the art that is configured to store and allow processor(s) access to information and data stored therein. In this example, the embodied program instructions are executable by at least one processor to cause the at least one processor to perform computer-implemented method 200.

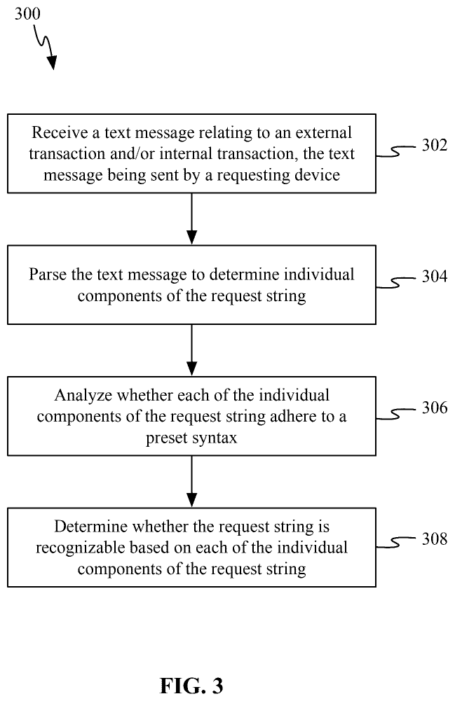

FIG. 3 is a flow chart of a computer-implemented method 300 for analyzing a text message for performing text message banking, according to one embodiment. Of course, more or less operations than those specifically described in FIG. 3 may be included in computer-implemented method 300, as would be understood by one of skill in the art upon reading the present descriptions.

Each of the operations of computer-implemented method 300 may be performed by any suitable component of the operating environment. For example, in various embodiments, computer-implemented method 300 may be partially or entirely performed by a cloud server, a portable computer, a handheld or wearable computer, a mobile device, one or more hardware processors of a computing device, an application operating on a computing device, a server device, a processing circuit having one or more processors therein, or some other device having one or more processors therein. The processing circuit, e.g., processor(s), chip(s), and/or module(s) implemented in hardware and/or software, and preferably having at least one hardware component, may be utilized in any device to perform one or more operations of computer-implemented method 300. Illustrative processors include, but are not limited to, a CPU, an ASIC, a FPGA, etc., combinations thereof, or any other suitable computing device known in the art.

In one embodiment, computer-implemented method 300 may be performed by an enterprise server that is configured to process electronic external transaction and/or internal transaction requests and manage accounts that are accessible to the electronic banking system. Although computer-implemented method 300 describes the use of text messages for banking, any form of short form or long form message on any platform may be used for initiating an action related to an external transaction and/or internal transaction for an account, such as Facebook® Messenger messages, Apple® Facetime® messages, WhatsApp™ messages, etc. Moreover, computer-implemented method 300 is described as being performed by an enterprise server; however, any suitable computing device may be used, alone or in combination with other electronic devices, to perform computer-implemented method 300 in various embodiments.

In operation 302, the enterprise server receives all or a portion of a text message relating to an external transaction and/or internal transaction. The text message is sent by a requesting device to initiate a text message banking session, and may be received by the enterprise server for processing thereof, either directly or via one or more intermediary devices, routers, switches, etc. In some examples, the requesting device may be a mobile device of a user, a smartphone, tablet computer, etc., that is connected to a cellular network or Wi-Fi network capable of originating and carrying a text message from the requesting device to the enterprise server.

The enterprise server determines whether the text message comprises a request string that is recognizable by the enterprise server in operations 304-308. The text message may not include a request string at all (in the case of messages mistakenly sent to the enterprise server), but the enterprise server will attempt to identify a request string from the text message by default.

In operation 304, the enterprise server parses the text message to determine individual components of the request string, thereby generating individual portions that the enterprise server can analyze to determine whether those components are recognizable parameters for a request string. ML and/or AI algorithm(s) may be utilized in this determination process, in several embodiments.

In operation 306, the enterprise server analyzes whether each of the individual components of the request string adhere to a preset syntax, such as those described herein or others known in the art. ML and/or AI algorithm(s) may be utilized in this analysis process, in several embodiments.

In operation 308, the enterprise server determines whether the request string is recognizable based on each of the individual components of the request string. In one approach, this analysis may ensure that each of the individual components of the request string adhere to the preset syntax that is able to be understood and processed by the enterprise server.

In one embodiment, the enterprise server may utilize a ML algorithm and/or AI algorithm to determine whether the text message comprises a request string that is recognizable by the enterprise server. Moreover, this ML and/or AI algorithm may learn, update, and adjust to identify incorrect request strings in the future and make better suggestions on how to properly enter the request string. In a further embodiment, the ML and/or AI algorithm may learn how to identify incorrectly entered request strings and still analyze and process the request string without requiring re-entry by the user.

The ML and/or AI algorithm is trained based on two training data sets, one set having correctly formulated request strings and one set having incorrectly formulated request strings. These incorrectly formulated request strings may be similar to correct request strings, but have one or more defects therein that material affect the ability to process the request. This defect or defects may take any form within the request string, such as a mis-entered or unrecognizable date, incorrect code used for the type or manner of the external transaction and/or internal transaction, incorrect code for the action to be performed, incorrect order for the parameters in the request string, too many or too few parameters in the request string, etc. By training the ML and/or AI algorithm on both recognizable and unrecognizable request strings, the ML and/or AI algorithm will be able to identify those request strings which can be processed (and are entered correctly) and those which need to be re-entered due to a defect in the request string. Further, the ML and/or AI algorithm may be able to suggest or recommend how to adjust the request string to overcome the defect(s) found therein, and may, over time, learn how to overcome defect(s) within a search string without requiring re-entry based on learning from past users' actions regarding request string entry.

In one embodiment, the preset syntax may include: a) a first indication of a manner for conducting the external transaction and/or internal transaction, b) a second indication of an action to process in association with the external transaction and/or internal transaction, and c) an eight-digit date associated with the external transaction and/or internal transaction. These parameters may be required to be received in this exact order, or may be received in any order as long as all required parameters are included in the request string.

More parameters may be included in this preset syntax as being able to be recognized by the enterprise server, but may not be required to be entered. For example, the syntax recognizable from the request string may also include an indication code that specifies a nature of the external transaction and/or internal transaction (e.g., a future payment or transfer, a recurring payment or transfer, a new payment or transfer, etc.), an identifier that specifies a particular account for performance of the external transaction and/or internal transaction (useful when the requesting device or user profile indicates multiple accounts that are available for text banking services to be performed thereon), an amount of money associated with the external transaction and/or internal transaction (useful when setting up new transfers or payments and when modifying an existing payment or transfer), a currency associated with the external transaction and/or internal transaction (useful for foreign transactions), a manner for conducting the external transaction and/or internal transaction (e.g., ACH, wire transfer, Zelle®, RTP, SWIFT, EFT, etc.).

In one embodiment, the action to process in association with the external transaction and/or internal transaction may be one of a set of actions pre-authorized for being conducted via text messaging banking. These actions may be different for different account types (e.g., checking accounts can have debits, savings accounts can have transfers, etc.), and may be processed using different manners for the different accounts. Some example actions include, but are not limited to, cancel payment, cancel transfer, retrieve and/or view one or more next transfers and/or payments, skip one or more next payment(s) or charge(s), initiate new payment, initiate new transfer, etc.

In one embodiment, the action may be one of: cancel payment or transfer, retrieve and/or view one or more next transfers and/or payments, and skip one or more next payment(s) or charge(s). Each of these actions may be denoted by a preset indication code, which when received in the request string, will be understood by the enterprise server as being related to performing the associated action on the at least one account.

In an embodiment, the indication code associated with an action to process in association with the external transaction and/or internal transaction may selected from a group comprising: a code to cancel a future transaction, a code to skip a next payment or charge, a code to initiate a new payment, and a code to initiate a new transfer.

Computer-implemented method 300 may be implemented in a system and/or a computer program product. For example, a system may include a processing circuit and logic integrated with the processing circuit, executable by the processing circuit, or integrated with and executable by the processing circuit. By integrated with, what is meant is that the processing circuit is a hardware processor that has hardcoded logic included therewith, such as an ASIC, a FPGA, etc. By executable by, what is meant is that the processing circuit is configured to execute software logic to achieve functionality dictated by the software logic. In this example, the logic is configured to cause the processing circuit to perform computer-implemented method 300.

In another example, a computer program product may include a computer-readable storage medium having program instructions embodied therewith. The computer-readable storage medium may be any suitable storage device known in the art that is configured to store and allow processor(s) access to information and data stored therein. In this example, the embodied program instructions are executable by at least one processor to cause the at least one processor to perform computer-implemented method 300.

FIG. 4 illustrates an example of a text message conversation 400 for performing text message banking. Although particular phrases, syntax, requests, and responses are shown in FIG. 4, these are exemplary only and not meant to be limiting on the invention in any way. In this example, a user has sent a message to a known contact of the phone—“Bank,” which has a text messaging address (or number) of 62554. The user must know what number to send the text messages to in order to reach the enterprise server which can process the request. The appropriate number to send text messages to may be provided to the user during or after the process of registering the requesting device (here, a smartphone) for conducting text message banking, in several embodiments.

In message 402, the user has sent a request string “WIRE 1 CHK 10032025.” This request string may be formulated to adhere to a preset syntax that is recognizable by the enterprise server (which can receive text messages sent to number 62554). In this example, the syntax may take the following form: “TYPE CODE ACCOUNT DATE,” where “TYPE” parameter describes the type of external transaction and/or internal transaction(s) that will be viewed, modified, initiated, or cancelled; “CODE” parameter describes the action to be performed for the external transaction and/or internal transaction(s); “ACCOUNT” parameter describes a specific account for which the external transaction and/or internal transaction will be performed; and “DATE” parameter indicates the date or starting date associated with the external transaction and/or internal transaction(s), here having the format “DDMMYYYY.”

In this example, the “TYPE” parameter indicates which type of external transaction and/or internal transaction(s) for which performance is being requested. The user has indicated a type of ACH, meaning that the enterprise server will only search for ACH type transactions in the associated account.

The “CODE” parameter indicates one of many different actions that may be performed for the related external transaction and/or internal transaction(s), Here, the user has requested an action related to the code “1,” which indicates retrieval and viewing of the next three ACH transactions.

The “ACCOUNT” parameter indicates which specific account to search for the next three ACH transactions. In this example, the account entered by the user is the user's checking account, denoted by “CHK,” that is associated with the user profile of the user.

The “DATE” parameter indicates the starting date for searching for external transactions and/or internal transactions in the checking account, here having the value of “10032025” indicating a starting date of Mar. 10, 2025.

In message 404, the enterprise server responds with the requested information, having determined that the syntax of the request string is recognizable, and that the requesting device is registered for conducting text message banking with the enterprise server (via a previously performed registration process).

The returned information shown in FIG. 4 is a preamble stating “The next three wire transfers scheduled for your checking account are listed below:” followed by the relevant information about the next three transactions. The first scheduled ACH transaction will be conducted on Mar. 11, 2025 in the amount of $50.00 payable to a payee having an account nickname in the system of “Mom” (probably denoting the user's mother's account). The second scheduled ACH transaction will be conducted on Mar. 15, 2025 in the amount of $26.12 payable to a payee having an account nickname in the system of “Credit Card” (probably denoting the user's credit card account). The third scheduled ACH transaction will be conducted on Mar. 28, 2025 in the amount of $1268.12 payable to a payee having an account nickname in the system of “Property Taxes” (probably denoting a governmental account for remitting property taxes for a property owned by the user). In the event that a payee does not have a nickname in the system, the full account number may be returned in some approaches.

In message 406, the user submits a request string of “WIRE 9 15032025,” which has a syntax of “TYPE CODE DATE.” In this example, the “TYPE” parameter is “WIRE” denoting a wire transfer, the “CODE” parameter is “9” denoting canceling an external transaction and/or internal transaction, and the “DATE” parameter is “15032025” denoting a date of Mar. 15, 2025. The “ACCOUNT” parameter may be an optional parameter for use in the syntax, and may not be needed in this instance since no other wire transactions are scheduled on Mar. 15, 2025 for any account associated with the user profile. If another wire transaction is scheduled on Mar. 15, 2025 in another account, the enterprise server may send a response message indicating that the user needs to indicate which account to cancel the wire transaction scheduled for Mar. 15, 2025, in an approach.

In response to message 406, the enterprise server sends message 408 indicating that the user's request to cancel the wire transaction on Mar. 15, 2025 was received and has been processed. This message 406 will be sent by the enterprise server subsequent to actually processing the cancellation of the wire transaction on Mar. 15, 2025 for the user's checking account.

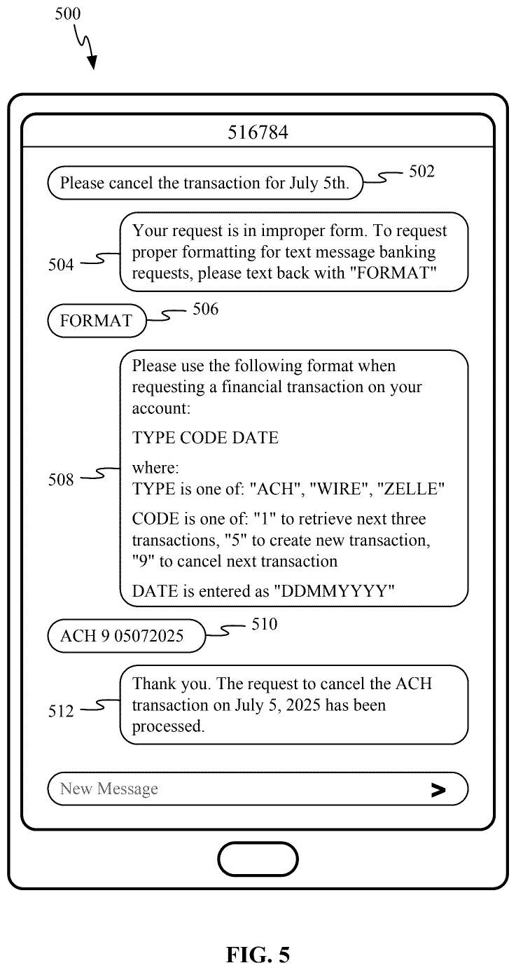

FIG. 5 illustrates an example of a text message conversation for performing text message banking. Although particular phrases, syntax, requests, and responses are shown in FIG. 5, these are exemplary only and not meant to be limiting on the invention in any way. In this example, a user has sent a message to a number not saved in the phone—“516784.” The user must know what number to send the text messages to in order to reach the enterprise server which can process the request. The appropriate number to send text messages to may be provided to the user during or after the process of registering the requesting device (here, a smartphone) for conducting text message banking, in several embodiments.

In message 502, the user has sent a message asking, “Please cancel the transaction for July 5th.” This request does not appear to be in a recognizable syntax that the enterprise server is capable of processing.

Therefore, in message 504, the enterprise server sends a response message indicating the following, in plain language easily understandable by the user: “Your request is in improper form. To request proper formatting for text message banking requests, please text back with ‘FORMAT’,” which provides the user with a clear path to receive instructions on how to properly communicate a request to the enterprise server.

In message 506, the user requests the proper formatting by typing “FORMAT” as previously indicated by the enterprise server in message 504.

Upon receiving message 504, the enterprise server may send out a preformulated message that includes instructions on proper syntax for requesting a certain action for an external transaction and/or internal transaction. In this example, the message 508 includes the following information:
Please use the following format when requesting an external transaction and/or internal transaction on your account:
TYPE CODE DATE
where:
TYPE is one of: “ACH”, “WIRE”, “ZELLE”
CODE is one of: “1” to retrieve next three transactions, “5” to create new transaction, “9” to cancel next transaction
DATE is entered as “DDMMYYY”

This message 508 includes very specific information on how to properly formulate a request string for processing by the enterprise server. In other approaches, this message will include any or all relevant information that describes one or more other recognizable syntaxes for use in formulating request strings in conducting text message banking.

In message 510, the user submits a request string of “ACH 9 05072025.” This request string is formulated in accordance with the syntax provided in message 508. In this example, the syntax chosen by the user has following form: “TYPE CODE DATE,” where “TYPE” parameter describes the type of external transaction and/or internal transaction(s) that will be viewed, modified, initiated, or cancelled; “CODE” parameter describes the action to be performed for the external transaction and/or internal transaction(s); and “DATE” parameter indicates the date or starting date associated with the external transaction and/or internal transaction(s), here having the format “DDMMYYYY.”

In this example, the “TYPE” parameter indicates which type of external transaction and/or internal transaction(s) for which performance is being requested. The user has indicated a type of ACH, meaning that the enterprise server will only manipulate ACH type transactions in the associated account.

The “CODE” parameter indicates one of many different actions that may be performed for the related external transaction and/or internal transaction(s), Here, the user has requested an action related to the code “9,” which indicates cancellation of the next ACH transaction for the related account.

The “DATE” parameter indicates the date associated with one or more external transactions and/or internal transactions in the relevant account, here having the value of “05072025” indicating a date of Jul. 5, 2025.

In response to message 510, the enterprise server sends message 512 indicating that the user's request to cancel the ACH transaction on Jul. 5, 2025 was received and has been processed. This message 512 will be sent by the enterprise server subsequent to actually processing the cancellation of the ACH transaction on Jul. 5, 2025 in the user's related account.

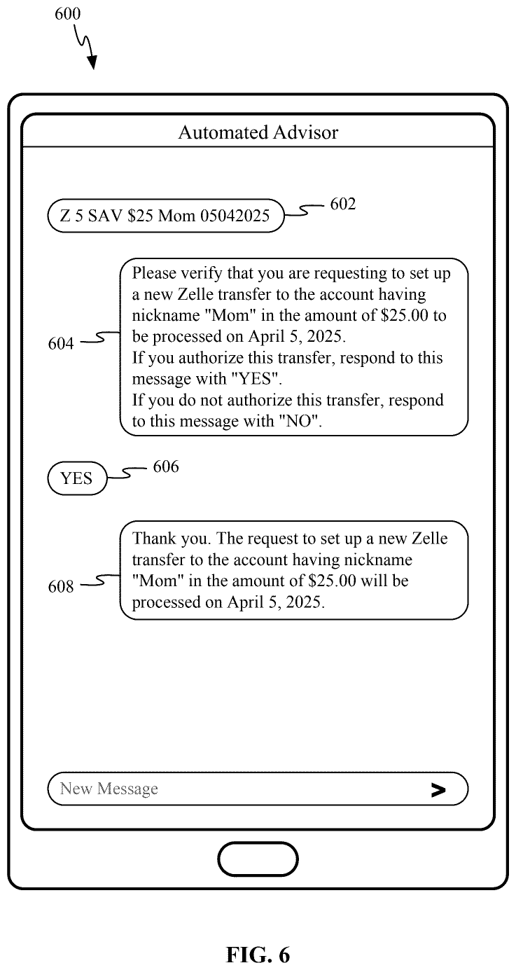

FIG. 6 illustrates an example of a text message conversation 600 for performing text message banking. Although particular phrases, syntax, requests, and responses are shown in FIG. 6, these are exemplary only and not meant to be limiting on the invention in any way. In this example, a user has sent a message to a known contact of the phone—“Automated Advisor.” The user must know what number to send the text messages to in order to reach the enterprise server which can process the request, and in this example the user has saved this information to the mobile device under the contact name of Automated Advisor. The appropriate number to send text messages to may be provided to the user during or after the process of registering the requesting device for conducting text message banking, in several embodiments.

In message 602, the user has sent a request string “Z 5 SAV $25 Mom 05042025.” This request string may be formulated to adhere to a preset syntax that is recognizable by the enterprise server. In this example, the syntax may take the following form: “TYPE CODE ACCOUNT AMOUNT RECIPIENT DATE,” where “TYPE” parameter describes the type of external transaction and/or internal transaction that will be viewed, modified, initiated, or cancelled; “CODE” parameter describes the action to be performed for the external transaction and/or internal transaction; “ACCOUNT” parameter describes a specific account for which the external transaction and/or internal transaction will be performed; “AMOUNT” parameter indicates a monetary amount for the external transaction and/or internal transaction; “RECIPIENT” parameter indicates the recipient account for the external transaction and/or internal transaction; and “DATE” parameter indicates the date or starting date associated with the external transaction and/or internal transaction(s), here having the format “DDMMYYYY.”

In this example, the “TYPE” parameter indicates which type of external transaction and/or internal transaction(s) for which performance is being requested. The user has indicated a type of “Z,” meaning that the enterprise server will manage Zelle® type transactions in the associated account.

The “CODE” parameter indicates one of many different actions that may be performed for the related external transaction and/or internal transaction(s), Here, the user has requested an action related to the code “5,” which indicates setting up a new transfer or payment.

The “ACCOUNT” parameter indicates which specific account to take money from in the selected Zelle® transfer. In this example, the user has indicated “SAV” denoting the user's savings account, that is associated with the user profile of the user.

The “AMOUNT” parameter indicates a monetary amount of $25 for the external transaction and/or internal transaction. The enterprise server will verify whether this amount of money is available in the user's savings account prior to processing this request.

The “RECIPIENT” parameter indicates a recipient account having a nickname of “Mom” (probably indicating the user's mother's account) for the external transaction and/or internal transaction.

The “DATE” parameter indicates the date for setting up the new Zelle® transfer into the user's Mom's account in the amount of $25. In this example, the “DATE” parameter has the value of “05042025” indicating a date of Apr. 5, 2025.

In message 604, in response to message 602, the enterprise server responds with a statement regarding the requested transfer set up, having determined that the syntax of the request string is recognizable, and that the requesting device is registered for conducting text message banking with the enterprise server (via a previously performed registration process). An example response message 604 reads: “Please verify that you are requesting to set up a new Zelle transfer to the account having nickname “Mom” in the amount of $25.00 to be processed on Apr. 5, 2025. If you authorize this transfer, respond to this message with ‘YES’. If you do not authorize this transfer, respond to this message with ‘NO’.”

In message 606, the user has responded with “YES,” indicating a desire to move forward with the requested transfer.

In response to message 606, the enterprise server sends message 608 indicating that the user's request to set up a new Zelle® transfer to the account having nickname “Mom” in the amount of $25.00 will be processed on Apr. 5, 2025. This message 608 will be sent by the enterprise server subsequent to actually setting up the new Zelle® transfer scheduled for Apr. 5, 2025 from the user's savings account.

According to one embodiment, the techniques described herein are implemented by one or more special-purpose computing devices (i.e., computing devices specially configured to perform certain functionality). The special-purpose computing devices may be hard-wired to perform the techniques, or may include digital electronic devices such as one or more ASICS, FPGAs, or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICS, FPGAS, or NPUs with custom programming to accomplish the techniques. The special-purpose computing devices may be desktop computer systems, portable computer systems, handheld devices, networking devices or any other device that incorporates hard-wired and/or program logic to implement the techniques.

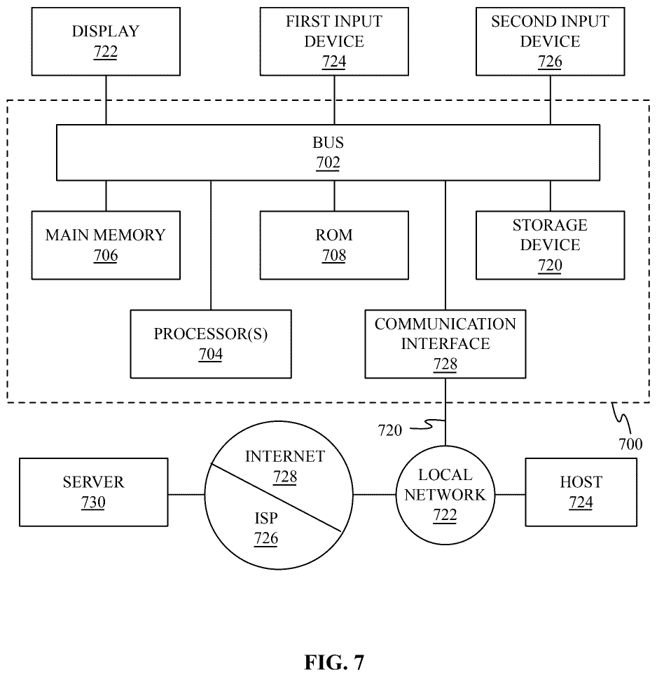

For example, FIG. 7 is a block diagram that illustrates a computer system 700 upon which an embodiment of the invention may be implemented. Computer system 700 may be of any type known in the art, such as a mobile device (smartphone, tablet, laptop, etc.), desktop computer, server, appliance, host, client, terminal, etc. As an option, computer system 700 may be implemented in conjunction with features from any other embodiments listed herein, such as those described with reference to any of FIGS. 1-6. Referring again to FIG. 7, computer system 700 includes a bus 702 or other communication mechanism for communicating information and data, and one or more hardware processors 704 coupled with bus 702 for processing information and data. The hardware processor(s) 704 may be of any type, for example, a general-purpose microprocessor, a central processing unit (CPU), a graphics processing unit (GPU), a microcontroller, etc.

Computer system 700 also includes a main memory 706 coupled to bus 702 for storing information and instructions to be executed by the processor(s) 704. Main memory 706 stores an operating system (OS). The OS includes instructions for handling basic system services and for performing hardware dependent tasks. Main memory 706 may additionally include instructions that cause computer system 700 to perform processes of the various embodiments described herein. In some embodiments, these instructions may be a subset of the OS or may be part of the instructions for an application.

In some embodiments, main memory 706 also may be used for storing temporary variables or other intermediate information during execution of instructions to be executed by processor(s) 704. Such instructions, when stored in non-transitory storage media accessible to processor(s) 704, render computer system 700 into a special-purpose machine that is customized to perform the operations specified in the instructions. In some embodiments, main memory 706 may include volatile memory (e.g., high-speed random-access memory), non-volatile memory (e.g., flash memory), a combination of volatile and non-volatile memory, and/or any other type of memory.

Main memory 706 may also include instructions for controlling other aspects of computer system 700, such as communication instructions to facilitate communicating with one or more additional devices (e.g., for peer-to-peer data sharing, to connect to a server through the Internet for cloud-based data sharing, etc.); graphical user interface (GUI) instructions to facilitate GUI processing; image processing instructions to facilitate image-related processing and functions; input processing instructions to facilitate input-related processes and functions (e.g., mouse cursor, touch input, etc.); audio processing instructions to facilitate audio-related processes and functions; and camera instructions to facilitate camera-related processes and functions, etc. The instructions described above are merely exemplary and main memory 706 may include additional and/or other instructions in some embodiments. The above-identified instructions need not be implemented as separate software programs or modules. Various functions of computer system 700 may be implemented in hardware and/or in software, including in one or more signal processing and/or application specific integrated circuits.

Computer system 700 may further include a read-only memory (ROM) 708 or other static storage device coupled to bus 702 for storing static information and instructions for processor(s) 704. A storage device 710, such as a magnetic disk or solid-state disk, is provided and coupled to bus 702 for storing information and instructions.

Computer system 700 may be coupled via bus 702 to a display 712, such as a liquid crystal display (LCD), light emitting diode (LED) display, touchscreen display, electronic ink display, cathode ray tube (CRT) monitor, or any other kind of device for displaying information to a user. A first input device 714, such as a keyboard or virtual keyboard that provides for selection of alphanumeric and/or other characters, may be coupled to bus 702 for communicating information and command selections to processor 704.

Alternatively, or in addition, computer system 700 may receive user input via a second input device 716, such as a mouse, a trackball, a trackpad, a touchscreen, a slider, and/or cursor direction keys. The second input device 716 may be configured for providing direction information, communicating command selections to processor 704, controlling cursor movement on display 712, etc. The second input device 716 may have at least two degrees of freedom in two axes, a first axis (e.g., x) and a second axis (e.g., y), that allows the second input device 716 to specify positions in a plane. The display 712 may be configured to receive user input via one or more pressure-sensitive sensors, multi-touch sensors, and/or gesture sensors. Alternatively, or in addition, computer system 700 may receive user input via a microphone, video camera, and/or some other kind of user input device (not shown).

Computer system 700 may implement the techniques described herein using customized hard-wired logic, one or more ASICs or FPGAs, firmware, and/or program logic which in combination with the computer system causes, configures, or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein in various embodiments. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, solid-state or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a programmable read-only memory (PROM), and erasable PROM (EPROM), a FLASH-EPROM, non-volatile random-access memory (NVRAM), any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio wave and infrared data communications.

Various forms of media may be involved in carrying one or more sequences of one or more instructions to processor(s) 704 for execution. For example, the instructions may initially be carried on a magnetic disk or solid-state drive of a remote computer. The remote computer can load the instructions into its dynamic memory and send the instructions over a network, via a network interface controller (NIC), such as an Ethernet controller or Wi-Fi controller. A NIC local to computer system 700 can receive the data from the network and place the data on bus 702. Bus 702 carries the data to main memory 706, from which processor(s) 704 retrieves and executes the instructions. The instructions received by main memory 706 may optionally be stored on storage device 710 either before or after execution by processor(s) 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a LAN card to provide a data communication connection to a compatible LAN. Wireless links may also be implemented. In any such implementation, communication interface 718 sends and receives electrical, electromagnetic, or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. The received code may be executed by processor(s) 704 as it is received, and/or stored in storage device 710, or other non-volatile storage for later execution.

One or more peripheral devices may be coupled to computer system 700, such as various sensors and subsystems. Some example peripheral devices include, but are not limited to, a camera subsystem, a wired communication subsystem, a wireless communication. subsystem, an audio subsystem, an I/O subsystem, etc. The peripheral devices may communicate with the processor(s) 704 directly through bus 702 or via a peripherals interface. In one example, an orientation sensor (e.g., a gyroscope) and an acceleration sensor (e.g., an accelerometer) may be coupled to the peripherals interface to facilitate orientation and acceleration functions for computer system 700.

In several examples, computer system 700 may include a camera subsystem that is coupled to one or more optical sensors (e.g., a charged coupled device (CCD) optical sensor, a complementary metal-oxide-semiconductor (CMOS) optical sensor, etc.). The optical sensors may facilitate camera functions, such as capturing image and/or video data. A wired communication subsystem and/or wireless communication subsystem may also be included to facilitate communication functions via one or more connections.

In some examples, computer system 700 may include a wireless communication subsystem having one or more radio frequency receivers and transmitters, optical receivers, and transmitters. These receivers and transmitters may be implemented to operate over one or more communication networks, such as a GSM network, a Wi-Fi network, a Bluetooth network, etc. An audio subsystem may be included in computer system 700, with the audio subsystem being coupled to a speaker or an output audio (e.g., to output music, voice navigation instructions, signals, etc.). Additionally or alternatively, the audio subsystem may be coupled to a microphone to facilitate audio input, such as voice-enabled functions in one example.

In an example, computer system 700 may include an I/O subsystem that is configured for managing transfer of data between input/output peripheral devices, such as a display, a touch screen, etc., and bus 702, e.g., via a peripherals interface. The I/O subsystem may include a touch-screen controller and/or other input controllers to facilitate the transfer between input/output peripheral devices and bus 702 of computer system 700. In this example, the touch-screen controller may be coupled to a touch screen for detecting contact and movement on the touch screen using any of multiple touch sensitivity technologies.

While the components illustrated in FIG. 7 are shown separately, one of ordinary skill in the art will recognize that two or more components may be integrated together, such as into one or more integrated circuits. In addition, two or more components may be coupled together by one or more communication buses or signal lines. Also, while many of the functions are described as being performed by a particular component, one of ordinary skill in the art will recognize that the functions described with respect to FIG. 7 may be split into multiple integrated circuits.

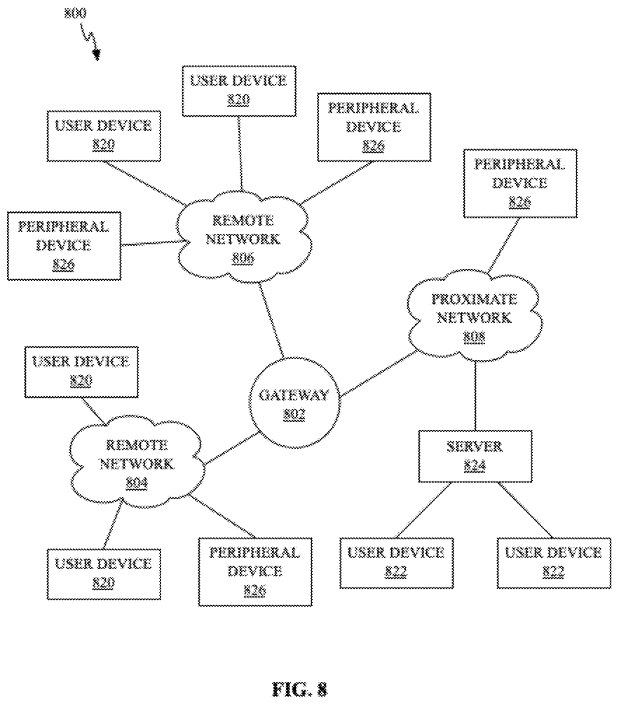

FIG. 8 illustrates a network architecture 800, in accordance with one or more embodiments. The computer system 700 of FIG. 7 may utilize any of the components described in network architecture 800 of FIG. 8, in various approaches. As an option, the present architecture 800 may be implemented in conjunction with features from any other embodiments listed herein, such as those described with reference to any of FIGS. 1-6. Of course, however, network architecture 800 of FIG. 8 and others presented herein may be used in various applications and/or in permutations which may or may not be specifically described in the illustrative embodiments listed herein. Further, network architecture 800 presented herein may be used in any desired environment.

One or more remote and/or proximate networks may be provided in network architecture 800. As shown in FIG. 8, network architecture 800 includes a first remote network 804 and a second remote network 806. A gateway 802 may be coupled between the remote networks 804, 806 and a proximate network 808. In the context of the present network architecture 800, the networks 804, 806, 808 may each take any form including, but not limited to, a LAN, a WAN such as the Internet, a storage area network (SAN), a public switched telephone network (PSTN), an internal telephone network, etc. Additional networks may also be connected via the gateway 802 or some other connection device known in the art. These networks may be of a different type than the networks 804, 806, 808. For example, a network may be devoted to the Internet of Things (IOT) and may provide infrastructure and protocols for communication between all devices in the IOT, and between any devices in the IOT and one or more of the other networks. In another example, a network may be devoted to Industrial control, and may provide infrastructure and protocols for communication within and/or between facilities anywhere in the world, including automated devices, manufacturing lines, assembly lines, processing control software, etc.

In use, the gateway 802 serves as an entrance point from the remote networks 804, 806 to the proximate network 808. As such, the gateway 802 may function as a router, configured to direct a given packet of data that arrives at the gateway 802, and a switch, which furnishes the actual path in and out of the gateway 802 for a given packet. In some embodiments, router functionality and switching functionality may be embodied in one or more different or additional devices.

Further included in the network architecture 800 is at least one server 814 coupled to the proximate network 808, and which is accessible from the remote networks 804, 806 via the gateway 802. It should be noted that the server(s) 814 may include any type of computing device/groupware, and may be of any type of server, e.g., a data server, enterprise server, cloud server, etc. A plurality of user devices 812 may be coupled to any server 814. User devices 812 may include any device known by one of skill in the relevant art, such as a desktop computer, a laptop computer, a hand-held computer, a smartphone, a terminal, a port, a printer, an automated teller machine (ATM), a debit or credit card reader device, a point of sale (POS) device, or some other type or form of processing logic, etc. It should be noted that one or more user devices 810 may also be directly coupled to any of the remote networks 804, 806, in various embodiments.

A peripheral 816 or series of peripherals, e.g., scanners, printers, networked storage units, hard disk drives, wireless routers, ATM, debit or credit card reader device, POS device, etc., may be coupled to one or more of the networks 804, 806, 808. It should be noted that databases, servers, mainframes, and/or additional components may be utilized with and/or integrated into any type of network element coupled to the networks 804, 806, 808. In the context of the present descriptions, a network element may refer to any component of a network, system, device, and/or any device useable in a network.

According to some approaches, methods and systems described herein may be implemented with and/or utilized on virtual systems and/or systems which emulate one or more other systems, such as a UNIX® system which emulates a macOS® environment, a UNIX® system which virtually hosts a Microsoft Windows® environment, a Microsoft Windows® system which emulates a macOS® environment, etc. This virtualization and/or emulation may be enhanced using virtualization software, such as VMware ESX®, Microsoft Hyper-V®, Intel Simics®, etc., in some embodiments.

In more approaches, one or more of the networks 804, 806, 808 may represent a cluster of systems commonly referred to as a “cloud.” In a cloud or “cloud computing,” shared resources, such as processing power, peripherals, software, data processing, servers, storage, etc., are provided to any system that has access to the cloud and permission to access the specific resource, preferably in an on-demand relationship. This allows for access and distribution of services across many computing systems. Cloud computing typically involves an Internet or other high-speed connection (e.g., 5G, fiber optic, etc.) between the systems operating in the cloud, but other techniques of connecting the systems may also be used, as would be understood by one of skill in the relevant art.

The described methods, systems, and computer program products offer several technical advantages over existing solutions for external transactions and/or internal transactions (e.g., payments, money transfers, gifts, etc.). By enabling users to manage and/or cancel future transactions via offline text messaging (SMS and/or MMS), the embodiments described herein provide a more accessible and secure alternative for users who prefer or require non-web-based access to external transactions and/or internal transactions. This capability is particularly advantageous for users to manage their external transactions and/or internal transactions without the need for internet connectivity, thereby enhancing security and reducing the risk of unauthorized access.

Additionally, in some embodiments, encryption of data transmitted between the registered and authenticated sending device and the enterprise server ensures that sensitive information remains protected throughout the transaction process. Without encryption or other security procedures, data would be exposed to nefarious actors attempting to improperly gain access to such sensitive data.

In some embodiments, inclusion of machine learning further enhances functionality of the disclosed embodiments through adaptation and the ability to upgrade over time to improve performance based on user behavior, observed trends, transaction patterns, and changes to regulatory requirements, thereby providing a more personalized and efficient experience.

Furthermore, in some embodiments, the ability to selectively cancel upcoming external transactions and/or internal transactions via offline text messaging offers a user greater control over their external transactions and/or internal transactions. This feature is particularly beneficial in scenarios where users need to modify an external transaction and/or internal transaction on short notice, as it provides a quick, easy, and reliable option for a user to change an external transaction and/or internal transaction without needing a web-based interface or software installation on a user's computing device.

According to some embodiments, integration of a sensor module within the enterprise server also contributes to its robustness by monitoring and responding to various environmental conditions and changes, thereby ensuring consistent and reliable operation. Overall, these technical advantages position the disclosed embodiments as a superior solution for managing external transactions and/or internal transactions in a secure, accessible, and efficient manner.

Variations of the embodiments described herein are also possible, and the explicit description thereof in these descriptions is not required to provide one of skill in the relevant art with the ability to conceive of such variations when reading the present descriptions.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for a long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in query, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1. A method for conducting external transactions and/or internal transactions via text messaging, the method comprising:
receiving, by a server computing system, a text message relating to an external transaction and/or internal transaction, the text message being sent by a requesting device;
determining, by the server computing system, an identity of the requesting device based on a device identifier associated with the requesting device, the device identifier being selected from a group comprising: an international mobile equipment identity (IMEI) and an international mobile subscriber identity (IMSI);
verifying, by the server computing system, that the requesting device is registered for conducting external transactions and/or internal transactions for at least one account based on the device identifier;
determining, by the server computing system, whether the text message comprises a request string that is recognizable in response to verifying that the requesting device is registered; and
performing, by the server computing system, the external transaction and/or internal transaction in association with the at least one account in response to determining that the request string is recognizable.

2. The method of claim 1, wherein verifying that the requesting device is registered comprises:
determining, by the server computing system from the text message, a device identifier associated with the requesting device; and
determining, by the server computing system, that the device identifier is associated with a user profile accessible to the server computing system, the user profile being associated with the at least one account.

3. The method of claim 2, wherein the group from which the device identifier is selected further comprises: a media access control (MAC) address.

4. The method of claim 1, wherein determining, by the server computing system, whether the request string is recognizable by the server computing system comprises:
parsing, by the server computing system, the text message to determine individual components of the request string;
analyzing, by the server computing system, whether each of the individual components of the request string adhere to a preset syntax; and
determining, by the server computing system, that the request string is recognizable based on each of the individual components of the request string adhering to the preset syntax.

5. The method of claim 4, wherein the preset syntax comprises:
a first indication of a manner for conducting the external transaction and/or internal transaction;
a second indication of an action to process in association with the external transaction and/or internal transaction; and
an eight-digit date associated with the external transaction and/or internal transaction.

6. The method of claim 5, wherein the action to process in association with the external transaction and/or internal transaction is selected from a group comprising: view a preset number of scheduled payments or transfers, cancel payment or transfer, skip next payment or transfer in a scheduled series of payments or transfers, and initiate new payment or transfer.

7. The method of claim 5, wherein the second indication is a code selected from a group comprising: a first code to view a preset number of scheduled payments or transfers and a second code to cancel a scheduled payment or transfer.

8. The method of claim 1, wherein the request string specifies a nature of the external transaction and/or internal transaction, the nature being selected from a group comprising: a future payment or transfer, a recurring payment or transfer, and a new payment or transfer.

9. The method of claim 1, wherein the request string comprises an identifier that specifies a particular account for performance of the external transaction and/or internal transaction.

10. The method of claim 1, wherein the request string specifies a date associated with the external transaction and/or internal transaction.

11. The method of claim 1, wherein the request string specifies an amount of money associated with the external transaction and/or internal transaction.

12. The method of claim 1, wherein the request string specifies a currency associated with the external transaction and/or internal transaction.

13. The method of claim 1, wherein the request string specifies a manner for conducting the external transaction and/or internal transaction, the manner being selected from a group comprising: automated clearing house (ACH), wire transfer, Zelle®, real time payment (RTP), Society for Worldwide Interbank Financial Telecommunication (SWIFT), and electronic funds transfer (EFT).

14. The method of claim 1, further comprising:
sending, by the server computing system, a response text message to the requesting device in response to determining that the request string is not recognizable, the response text message comprising an example syntax to use in entering a request string; and
prior to performing the external transaction and/or internal transaction:
receiving, by the server computing system, a second text message from the requesting device; and
determining, by the server computing system, that the second text message comprises a second request string that is recognizable by the server computing system,
wherein the external transaction and/or internal transaction is performed based on the second request string.

15. The method of claim 1, further comprising sending, by the server computing system, a confirmation text message to the requesting device in response to processing the request string in association with performing the external transaction and/or internal transaction.

16. The method of claim 15, wherein the confirmation text message comprises a timestamp associated with performance of the external transaction and/or internal transaction in association with the at least one account.

17. The method of claim 1, further comprising, prior to receiving the text message:
receiving, by the server computing system, an electronic request to register the requesting device for conducting offline external transactions and/or internal transactions for the at least one account;
determining, by the server computing system, an identity of the requesting device;
determining, by the server computing system, that the requesting device is associated with an owner of the at least one account based on the identity of the requesting device; and
responsive to determining that the requesting device is associated with the owner of the at least one account, creating or modifying, by the server computing system, a user profile associated with the at least one account to indicate registration of the requesting device for conducting offline external transactions and/or internal transactions for the at least one account.

18. The method of claim 1, wherein verifying that the requesting device is registered for conducting offline external transactions and/or internal transactions for the at least one account comprises utilizing, by the server computing system, a third-party service to determine an identity of the requesting device.

19. A server computing system for conducting external transactions and/or internal transactions via text messaging, the system comprising:
at least one processor; and
a non-transitory computer-readable medium having instructions embodied therewith that, when executed by the at least one processor, cause the at least one processor to perform operations comprising:
receiving a text message relating to an external transaction and/or internal transaction, the text message being sent by a requesting device;
determining an identity of the requesting device based on a device identifier associated with the requesting device, the device identifier being selected from a group comprising: an international mobile equipment identity (IMEI) and an international mobile subscriber identity (IMSI);
verifying that the requesting device is registered for conducting external transactions and/or internal transactions for at least one account based on the device identifier;
determining whether the text message comprises a request string that is recognizable in response to verifying that the requesting device is registered; and
performing the external transaction and/or internal transaction in association with the at least one account in response to determining that the request string is recognizable.

20. A computer program product comprises a non-transitory computer-readable storage medium having program instructions embodied therewith that, when executed by at least one processor of a server computing system, cause the at least one processor to perform operations comprising:
receiving a text message relating to an external transaction and/or internal transaction, the text message being sent by a requesting device;
determining an identity of the requesting device based on a device identifier associated with the requesting device, the device identifier being selected from a group comprising: an international mobile equipment identity (IMEI) and an international mobile subscriber identity (IMSI);
verifying that the requesting device is registered for conducting external transactions and/or internal transactions for at least one account based on the device identifier;
determining whether the text message comprises a request string that is recognizable in response to verifying that the requesting device is registered; and
performing the external transaction and/or internal transaction in association with the at least one account in response to determining that the request string is recognizable.
